(19) United States
(12) Patent Application Publication
(10) Pub. No.: US 2014/0093636 A1
(43) Pub. Date: Apr. 3, 2014

(54) METHOD AND SYSTEM FOR MAKING PARTIALLY POPPED POPCORN

(71) Applicant: HALFPOPS, LLC, Woodinville, WA (US)

(72) Inventors: Michael Eaton FITZGERALD, Medina, WA (US); Kevin Arthur MEAGHER, Lynnwood, WA (US)

(73) Assignee: HALFPOPS, LLC, Woodinville, WA (US)

(21) Appl. No.: 13/631,525

(22) Filed: Sep. 28, 2012

(51) Int. Cl. A23L 1/18

(52) U.S. Cl. CPC A23L 1/1812
USPC 426/625; 426/508

(57) ABSTRACT

The present invention is directed to methods and systems for making partially popped popcorn. The invention comprises the steps of providing a plurality of corn kernels of the zea mays everta variety; soaking the plurality of corn kernels with water at substantially room temperature for a period of time sufficient to increase the pre-existing moisture content of less than about 15% water to a modified moisture content of greater than about 18% water; dewatering the soaking water away from the plurality of corn kernels; and forcing heated air upwardly through the perforated screen while the perforated screen is being vibrated such that the plurality of corn kernels having a modified moisture content of greater than about 18% water is suspended and heated above the perforated screen by the heated air thereby causing heating and expansion of the plurality of corn kernels to thereby yield the partially popped popcorn.

### TECHNICAL FIELD

The present invention relates generally to methods and systems for making edible food snacks and, more particularly, to methods for making partially expanded or popped kernels of grain such as, for example, partially popped popcorn.

### BACKGROUND OF THE INVENTION

Cereal-based food products are a prevalent source of nutrition for humans and livestock, particularly, corn, wheat and rice-based products. The individual kernels of these and other cereal grains may be processed in a variety of ways to produce numerous foodstuffs, including many forms of snack products.

Grain kernels are generally comprised of a relatively strong outer hull, referred to as a pericarp, a starchy interior material, referred to as endosperm, and the germ, which, upon germination, is the genesis of the underlying grain plant.

The hull/pericarp generally covers the exterior of the kernel. The endosperm comprises a large internal volume of the kernel and provides a source of energy for kernel germination and growth. Because the endosperm of the kernel is nutrient rich and comprises the majority of the kernel itself, food products derived from grain are primarily comprised of the endosperm material.

Popped corn is a well-known grain kernel-based snack food that is popular for both its flavor and texture. Without necessarily prescribing to any specific scientific theory, it is believed that the “popping” mechanism associated with popcorn is the result of the cooperation of the moisture contained in the endosperm and the containment and subsequent rupture of the pericarp. Typically, commercially available kernels of unpopped popcorn have moisture content within the endosperm of the kernels of about 13.5 to 14.5% (weight percentage basis). These kernels generally further comprise a pericarp structure that is strong and lacking any damage such as fractures, fissures or weak spots.

When the kernels are exposed to a sufficiently high temperature, the moisture in the endosperm is heated and expands within the pericarp structure (somewhat like a pressure-cooking vessel). As the moisture in the endosperm continues to expand, pressure continues to increase within the starchy endosperm contained within the pericarp. It has been estimated that the internal pressure contained in a good quality pericarp structure can be in the range of nine atmospheres or about 130 pounds per square inch (psi). When the pressure within the pericarp exceeds the capacity to retain it, the pericarp will rupture and explode. At which time, the moisture distributed throughout the endosperm abruptly expands, turning the kernel inside out and generating a fluffy endosperm, which is what is typically referred to as “popcorn.”

An alternative result occurs when the endosperm moisture content levels are greater than about 14% (weight percentage basis). Under appropriate endosperm moisture conditions, the kernels will only partially pop, whereby the endosperm only partially expands. Such partially or half popped kernels are sometimes referred to as “old maids.” Many popcorn consumers find the taste and texture of these partially or half popped kernels of corn desirable.

U.S. Pat. No. 5,284,666 to Graf discloses a method for preparing flavored, unpopped popcorn kernels involving partially dehydrating and soaking or coating the kernels in flavored liquid then drying. The resulting kernels maintain their flavor and may additionally be coated in a fluidized bed with a thin layer of oil for increased flavor. This produces low fat, flavored kernels with superior popping ability, shelf life, flavor and salt retention. This method, however, is not suitable for producing half popped popcorn because the kernel moisture content necessary for half popping is significantly higher, requiring a unique process for the production of half popped popcorn.

U.S. Pat. No. 7,579,036 to Meamber discloses a method for making partially/half-popped popcorn whereby a plurality of corn kernels are modified by heating in water for a period time sufficient to introduce cracks or fractures to the pericarp structure of at least some of the corn kernels. This method, however, is somewhat limited in that it involves a preheating in water step.

U.S. Pat. No. 8,201,492 to Cretors discloses a portable popcorn-popping machine that utilizes hot air for popping. A blower pushes up heated air through a perforated and horizontally positioned cylindrical drum while corn kernels are pushed through the drum as it rotates by an auger running the length of the cylinder. As the corn advances the hot air running through the rotating drum pops the kernels. This machine has previously been used to produce partially popped popcorn, however, the volume of partially popped popcorn produced has been found to be unsatisfactory.

Accordingly, there is a need in the art for new and improved methods and systems for making partially popped grain kernels, such as, partially popped popcorn, that is both simple and low cost and which will produce a product that is flavorful and provides a texture that is appealing to consumers. The present invention fulfills these needs and provides for further related advantages.

### SUMMARY OF THE INVENTION

In one embodiment, present invention is directed to a method for making partially popped popcorn. The invention comprises the steps of providing a plurality of corn kernels of the zea mays everta variety; soaking the plurality of corn kernels with water at substantially room temperature for a period of time sufficient to increase the pre-existing moisture content of less than about 15% water to a modified moisture content of greater than about 18% water; dewatering the soaking water away from the plurality of corn kernels; and forcing heated air upwardly through the perforated screen while the perforated screen is being vibrated such that the plurality of corn kernels having a modified moisture content of greater than about 18% water is suspended and heated above the perforated screen by the heated air thereby causing heating and expansion of the plurality of corn kernels to thereby yield the partially popped popcorn. The vibratory motion also serves to convey the individual kernels of popcorn (before and after partially popping) along a defined generally horizontal and outwardly spiralling pathway that results in uniform processing on a “first in/first out” basis.

### BRIEF DESCRIPTION OF THE DRAWINGS

In the drawings like reference numerals are used to designate like features throughout the several views of the drawings.

FIG. 1 is a schematic view of a series of devices (system) sequentially positioned on a factory floor useful for making partially popped popcorn in accordance with an embodiment of the present invention.

FIG. 2 is a side elevational view of a processor for partially popping popcorn in accordance with an embodiment of the present invention.

FIG. 3 is an elevational partial cut-away view of the processor shown in FIG. 2.

### DETAILED DESCRIPTION OF THE INVENTION

The present invention is directed to methods and systems for making edible food snack products and, more particularly, to methods for making partially expanded or popped kernels of grain such as, for example, partially popped popcorn. In the several embodiments disclosed herein, the methods and systems are described in the context of transforming unpopped kernels of commercially available “popcorn” into partially expanded/popped popcorn; however, it is to be understood that other kernels of grain having hard hulls and dense starchy interiors such as, for example, amaranth grain, sorghum, quinoa and millet are contemplated and within the scope of the present invention. Moreover, and as is appreciated by those skilled in the art, the term “popcorn” refers to corn of zea mays everta variety and thus should not be confused with other forms of corn (maize) such as flour corn (zea mays amylacea), dent corn (zea mays indentata), flint corn (zea mays indurate), sweet corn (zea mays saccharata and zea mays rugosa), or waxy corn (zea mays ceratina). As is further appreciated by those skilled in the art, kernels of corn of the zea mays everta variety have an outer pericarp structure and an interior volume that comprises an endosperm material. The endosperm material of commercially available kernels of the zea mays everta variety typically has a moisture content of 13.5 to 14.5% (weight percentage basis), or more generally less than about 15% on a weight percentage basis.

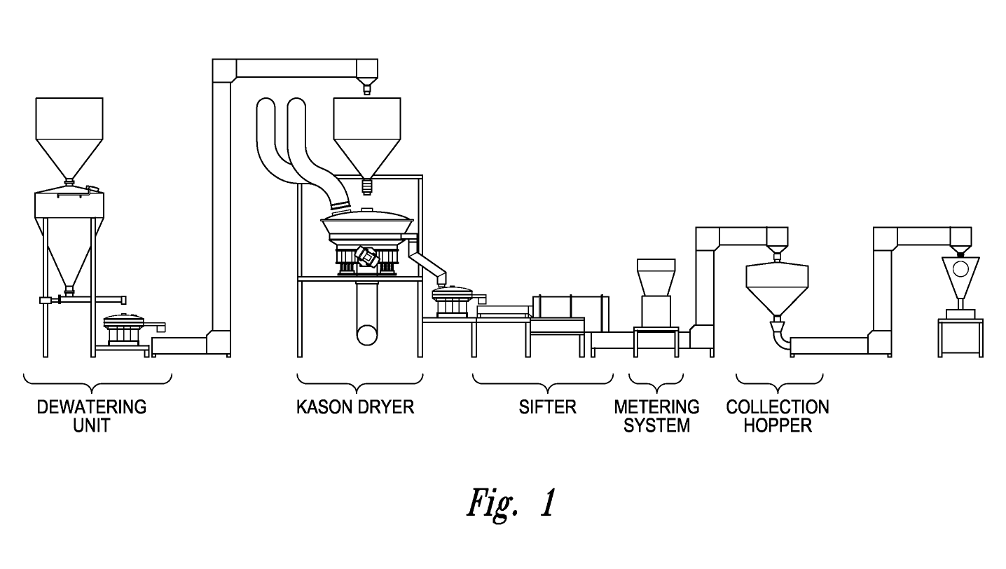

Thus, and in view of foregoing and with reference to FIG. 1, the present invention in one embodiment is directed to a system 10 for making partially popped popcorn. The system 10 sequentially includes a first staging hopper 12 connected to a soaking tank 14 for soaking a plurality of selected corn kernels of the zea mays everta variety with water, a dewatering unit 16 for removing excess water from the previously soaked and wetted corn kernels, a second staging hopper 18 connected to a processing unit 20 for partially expanding/popping unwetted corn kernels, a sifting unit 22 for removing unpopped popcorn and fragments thereof from the partially expanded/popped popcorn, a metering system 24 for determining the system's throughput and adding a selected amount of seasoning and/or other ingredients, a coating unit 26 for coating the partially expanded/popped popcorn with one or more seasonings and/or other ingredients, and a third collection hopper 28 connected to a bagger 30 for packaging the coated and partially expanded/popped popcorn.

More specifically, and at the beginning of the system 10, a first staging hopper 12 having a conical-shaped bottom portion 13 is used to stage a plurality of selected corn kernels (not shown) above the soaking tank 14. The selected corn kernels are then conveyed into the soaking tank 14 and filtered water (at more or less room temperature) is added so as to completely cover the corn kernels. The selected corn kernels are then allowed to soak in the water for a period of time sufficient to increase the pre-existing moisture content of less than about 15% water to a modified moisture content of greater than about 18% water on a weight percentage basis. The period of time for soaking with water is generally about 48 hours (shorter times of only 12 hours and longer times of up to a week were found to be possible, however the resulting food product tends to have poorer texture and less crunch) and the modified moisture content can be as high as 25% to 30% on a weight percentage basis, or even higher.

Next, the excess soaking water is drained from the soaking tank 14 and the wetted corn kernels are conveyed to a dewatering unit 16 for removing excess water away from the previously soaked and wetted corn kernels. The dewatering unit 16 may include a vibrating screen that together with gravity facilitates the removal of excess water away from the outer surfaces of the corn kernels.

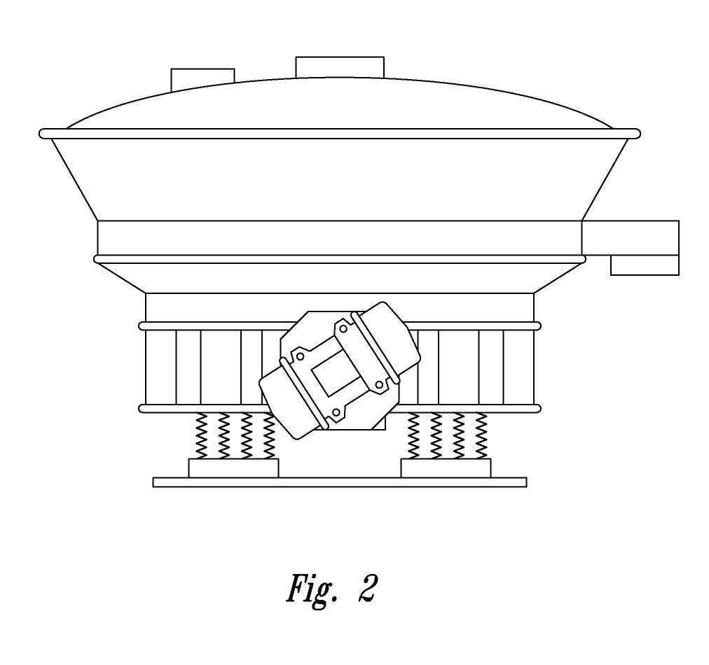

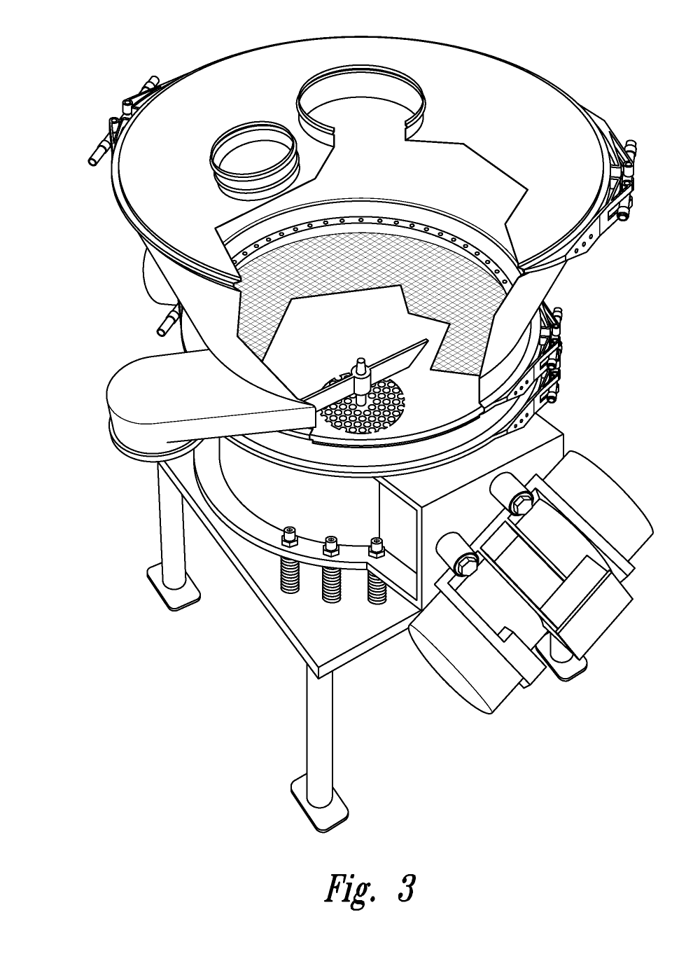

The plurality of dewatered corn kernels (now having a modified moisture content of greater than 18%) are then conveyed into the processor unit 20 by way of a top and centrally positioned processor inlet 21. As best shown in FIGS. 2 and 3, the processor unit 20 comprises a housing 23 about a processing chamber 25 and includes a perforated screen 27 positioned substantially horizontally within the housing 23 and below the processing chamber 25. The perforated screen 27 includes a plurality of holes (mesh) that are smaller in size than each of the plurality of corn kernels. The processor unit 20 also includes a bottom and centrally positioned heated air inlet 29 (which, in turn is connected to a blower and a heater (not shown)) configured to force heated air upwardly through the perforated screen 27 and into the processing chamber 25. The heated air is conveyed through the processing chamber 25 by means of lower and upper ducting 32.

The processing 20 still further includes a vibration unit 31 (motor) for controllably vibrating the perforated screen 27 and a circumferentially positioned processor outlet 35 for expelling partially popped popcorn out of the processing chamber 25. As shown, the housing 23 of the processor 20 is mounted onto a housing stand 33 by way of a plurality of springs 37. Each of the plurality of springs 35 has a spring tension that is controllably adjustable. In this configuration and when running, the vibration unit 31 vibrates the perforated screen 27 while the modified popcorn is being continuously added into the processing chamber 25 through processor inlet 21. The continuous heated air flow and vibration tend to separate and fluidize the individual kernels of popcorn, thereby maximizing the exposed surface area and, consequently, the rate at which heating can occur. The vibratory motion of the processor unit 20 also serves to convey the individual kernels of popcorn (before and after partially popping) along a defined generally horizontal and outwardly spiralling pathway that results in uniform processing on a “first in/first out” basis.

In this regard, it has been determined that partial popping results are sensitive to the rate at which the kernels are heated. If heated too quickly, the steam in the outer layers of the kernel can reach high pressures and rupture the hull before the starch in the center of the kernel is adequately gelatinized, leading to partially popped kernels with hard centers. Heating too slowly leads to entirely unpopped kernels: the tip of the kernel, where it attached to the cob, is not entirely moisture-proof, and when heated slowly, the steam can leak out of the tip fast enough to keep the pressure from rising sufficiently to break the hull and cause the pop. Thus, the heated air preferably has a temperature ranging from about 400° F. to about 450° F. In some embodiments, the heated air has a temperature of about 435° F. and the modified popcorn kernels are processed and conveyed through the processor unit 20 in a period of time of about 4 minutes.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

What is claimed is:

1. A method for making partially popped popcorn comprising the steps of:
providing a plurality of corn kernels of the zea mays everta variety, with each corn kernel having a pericarp structure and an interior volume comprising an endosperm material having a pre-existing moisture content of less than about 15% water on a weight percentage basis;
conveying the plurality of corn kernels into a soaking tank for soaking with water;
soaking the plurality of corn kernels with water at substantially room temperature for a period of time sufficient to increase the pre-existing moisture content of less than about 15% water to a modified moisture content of greater than about 18% water on a weight percentage basis;
dewatering the soaking water away from the plurality of corn kernels having a modified moisture content of greater than 18% water on a weight percentage basis;
conveying the plurality of dewatered corn kernels having a modified moisture content of greater than 18% into a processor by way of a top positioned processor inlet, wherein the processor comprises a housing about a processing chamber, a perforated screen positioned substantially horizontally within the housing and below the processing chamber with the perforated screen including a plurality of holes smaller in size than each of the plurality of corn kernels, a bottom positioned heated air inlet configured to force heated air upwardly through the perforated screen and into the processing chamber, a vibration unit for controllably vibrating the perforated screen, and a circumferentially positioned processor outlet for expelling partially popped popcorn out of the processing chamber;
forcing heated air upwardly through the perforated screen while the perforated screen is being vibrated by the vibration unit for a selected period of time and at a selected temperature such that the plurality of corn kernels having a modified moisture content of greater than about 18% water is suspended and heated above the perforated screen by the heated air thereby causing heating and expansion of the plurality of corn kernels to thereby yield the partially popped popcorn; and
expelling the partially popped popcorn out of the processing chamber by way of the circumferentially positioned processor outlet.

2. The method for making partially popped popcorn according to claim 1 wherein the period of time for soaking with water is about 48 hours.

3. The method for making partially popped popcorn according to claim 1 wherein the perforated screen is substantially circular.

4. The method for making partially popped popcorn according to claim 1, further comprising a housing stand, wherein the housing of the processor is mounted onto the housing stand by way of a plurality of springs.

5. The method for making partially popped popcorn according to claim 4 wherein each of the plurality of springs has a spring tension that is controllably adjustable.

6. The method for making partially popped popcorn according to claim 1 wherein the heated air has a temperature ranging from about 400° F. to about 450° F.

7. The method for making partially popped popcorn according to claim 6 wherein the heated air has a temperature of about 435° F. and the selected period of time is about 4 minutes.

8. The method for making partially popped popcorn according to claim 1 wherein the plurality of dewatered corn kernels having a modified moisture content of greater than 18% moves in an outwardly spiralling pathway while within the processor chamber.

9. A method for making partially popped popcorn comprising the steps of:
providing corn kernels of the zea mays everta variety, with each corn kernel having a pericarp structure and an interior volume comprising an endosperm material having a pre-existing moisture content of less than about 15% water on a weight percentage basis;
soaking the corn kernels with water at substantially room temperature for a period of time sufficient to increase the pre-existing moisture content of less than about 15% water to a modified moisture content of greater than about 18% water on a weight percentage basis;
dewatering the water away from the corn kernels having a modified moisture content of greater than 18% water;
conveying the corn kernels having a modified moisture content into a processor, wherein the processor comprises an internal perforated screen;
forcing heated air upwardly through the perforated screen while the perforated screen is being vibrated for a selected period of time and at a selected temperature such that the corn kernels having a modified moisture content of greater than about 18% water are suspended and heated above the perforated screen by the heated air thereby causing heating and expansion of the corn kernels to thereby yield the partially popped popcorn.

10. The method for making partially popped popcorn according to claim 9 wherein the corn kernels having a modified moisture content of greater than about 18% water are conveyed through the processor in a generally horizontal and an outwardly spiralling pathway.

11. Partially popped popcorn made in accordance with the process of claim 1 or 9.
